(19) United States
(12) Patent Application Publication
(10) Pub. No.: US 2007/0251941 A1
(43) Pub. Date: Nov. 1, 2007

(54) Modular microwave processing system

(76) Inventor: Kenneth R. Givens, Knoxville, TN (US)

Correspondence Address: ROBERT J. LAUF, 998 W. OUTER DRIVE, OAK RIDGE, TN, 37830, US

(21) Appl. No.: 11/412,041

(22) Filed: Apr. 26, 2006

(51) Int. Cl. H05B 6/64

(52) U.S. Cl. 219/678

(57) ABSTRACT

A modular microwave processing system includes a microwave source, a transmission line, and a detachable processing cavity or chamber. The chamber is adapted to maintain a controlled atmosphere surrounding a workpiece, and further contains an interface to engage the microwave transmission line so that power for heating the workpiece is introduced through the interface. The system is particularly suited for remote operation and for processing hazardous or accountable materials. It may also be adapted for operation in a hot cell or other controlled area while locating the microwave power source outside of the controlled area for ease of maintenance.

### BACKGROUND OF THE INVENTION

1. Field of the Invention

The invention pertains to apparatus and methods for microwave processing of materials. More particularly, the invention pertains to apparatus and methods for heating materials in a modular chamber adapted to receive power from a remote microwave source.

2. Description of Related Art

Microwaves have been commonly used in many industrial heating processes. Well-known examples include cooking, rubber processing, ceramic sintering, and others. It is standard practice in these systems to use a microwave power source that delivers microwave power to a closed applicator cavity via one or more waveguides, which typically are rigidly connected to a wall of the cavity. For continuous processing systems, openings are provided through which the material to be processed may pass into and out of the cavity, and these openings generally must be provided with chokes to minimize leakage of microwave power to the environment. For batch processing, one wall of the cavity is adapted to open so that workpieces may be taken in and out.

Many microwave heating systems require a controlled environment such as vacuum or an inert atmosphere to protect the workpiece from oxidation or contamination during processing, as described for example in U.S. Pat. No. 5,184,286 (Process for Manufacturing Tantalum Capacitors). Conversely, systems intended to heat radioactive or other hazardous materials must also be designed to maintain a closed environment to prevent the release of material to the environment and to protect the worker. Moreover, batch chemical production or pasteurization requires a sealed system to protect the product. It will be appreciated that the processes of opening the door, loading, securing the door, pumping and backfilling, venting, opening the door, and removing the workpiece and/or product are time and labor intensive. All the time involved in these operations represents dead time during which the microwave equipment is idle.

Some industrial processes may involve materials that are hazardous, radioactive, fissile, or for various other reasons must be controlled and accounted for. Material may be lost, spilled, or diverted during loading and unloading operations in a conventional microwave processing cavity. Furthermore, the processing of radioactive materials creates maintenance issues because contaminants from the processed materials may become dispersed throughout the interior of the waveguides, which are difficult to clean. Also, if the microwave power supply is located in a hot cell, contamination zone, or similar radiation control area, the complexity and expense of maintaining the equipment increases considerably.

Still other processes have been disclosed wherein a sample to be processed is sealed within an individual chamber such as that shown by Hargett in U.S. Patent Application Publication 2004/0179977. However, the sample chamber in that Application is constructed substantially of microwave-transparent materials and the sample chamber (actually sample holder) is intended to be placed within a microwave cavity or oven. As in previous techniques, the cavity itself is fairly conventional and in particular the metal walls of the cavity are rigidly connected to the microwave source.

Objects and Advantages

Objects of the present invention include the following: providing a microwave heating system that is suitable for processing hazardous materials; providing a microwave heating system that is easier to maintain; providing a microwave heating system that is adapted to process materials that must be kept secure and accounted for; providing a microwave heating system in which the processing cavity is a module that is readily separable from the microwave waveguide; providing a microwave heating system wherein the microwave power source may be located remotely from the processing chamber; providing a microwave heating system with improved capital equipment utilization rate; and, providing a microwave heating system in which a single power supply may be readily adapted to process different workpieces and/or products. These and other objects and advantages of the invention will become apparent from consideration of the following specification, read in conjunction with the drawings.

### SUMMARY OF THE INVENTION

According to one aspect of the invention, an apparatus for microwave processing comprises: a microwave source; a transmission line adapted to carry power from the microwave source; and, a movable processing chamber adapted to maintain a selected internal environment, the chamber having an interface adapted to receive microwave power from the transmission line, whereby the contents of the chamber may be processed by exposure to microwave power in the selected environment.

According to another aspect of the invention, a method for microwave processing comprises the following steps:

a. loading material to be processed into a portable metal chamber, the chamber having a securable opening and an interface adapted to admit microwave power from an external feed;

b. securing the opening;

c. moving the chamber into a position in which the interface engages the external feed; and,

d. applying microwave power through the interface and heating the material to a selected temperature for a selected time.

According to another aspect of the invention, a method for microwave processing comprises the following steps:

a. loading material to be processed into a portable metal chamber having a securable opening, a first interface adapted to admit microwave power from an external feed, and a second interface adapted to engage a second process input device, which may be least one of the following: an interface adapted for process feeds and egress, an interface adapted to accommodate a temperature sensor, and a mechanical feedthrough adapted to drive a movable mechanism;

b. securing the opening;

c. moving the chamber into a position where the first interface engages the microwave power feed and the second interface engages its respective input device; and,

d. applying microwave power to heat the material while engaging the second process input device to control a selected aspect of the heating process.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawing figures, wherein like numerals (if they occur in more than one view) designate the same elements. The features in the drawings are not necessarily drawn to scale.

FIG. 1 is a schematic diagram of one embodiment of the present invention.

FIG. 2 is a schematic diagram of another embodiment of the present invention.

FIG. 3 is a schematic diagram of another embodiment of the present invention.

### DETAILED DESCRIPTION OF THE INVENTION

In its most general form, the invention contains three components: first, a microwave power source; second, a transmission line to deliver the microwave power from the source to the process chamber; and, third, a modular or self-contained process chamber that forms the microwave applicator cavity when connected to the transmission line.

The microwave power source may operate at a relatively fixed frequency or it may be operated at multiple frequencies as are well known in the art. The power source may employ any conventional type of microwave generating device, including klystrons, gyrotrons, magnetrons, traveling wave tubes, and solid state power amplifiers. For relatively low-cost systems intended to operate in the ISM band at 2.45 GHz, a magnetron is particularly suitable.

The transmission line is preferably a conventional waveguide with internal dimensions selected based on the operating frequency being used. In some cases, the transmission line might include a length of coaxial line, terminated in an antenna or waveguide launcher where the process chamber is to interface. Alternatively, the antenna or launch structure may be integral with the chamber, in which case the power interface will comprise a coaxial feedthrough as is known in the art.

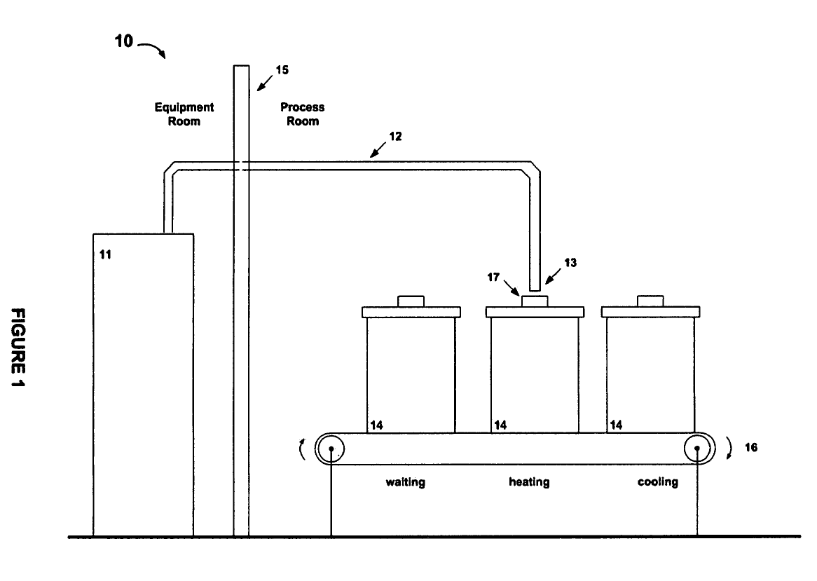

The process chamber is preferably constructed primarily of metal, with at least one window configured to interface with the microwave transmission line. The chamber may further contain gas or vacuum ports, observation windows, and instrument feedthrough points as are known in the art. The wall of the chamber may be actively cooled to prevent damage when high temperature processing is contemplated. It may also contain various features to prevent tampering, such as locks, tamper indicators, and the like. The process chamber is preferably of sufficient size to accommodate the workpiece(s) along with such ancillary items as fixtures, molds, insulation, thermocouples, and the like. It is contemplated that the chamber is movable to some degree and it is preferably portable. However, as used herein, the term “portable” should not be construed to mean “man portable”, because the loaded chamber will often be quite heavy and may require equipment such as a forklift or conveyor to move it from place to place. Furthermore, the invention may be carried out using a relatively small number of chambers that simply move back and forth on a fixed track. In that mode, one chamber can be cooled, vented, loaded, etc., while another is being heated, thereby increasing throughput and improving utilization of the microwave power supply. The optimal number of chambers will depend on the amount of time spent in each step. For example, if loading/evacuation and cooling/unloading steps each take about as long as the heating step, then three chambers as shown schematically in FIG. 1 will allow the microwave generator to enjoy a high utilization rate.

Various features of the invention will be shown in detail by the following examples, which will illustrate several embodiments of the invention and describe their operation.

### EXAMPLE 1

Referring to FIG. 1, the general layout of the invention is shown at 10. A microwave power source 11 provides microwave power via transmission line 12 to the output point 13. Modular process chambers 14, three of which are shown, have been pre-assembled and sealed. Each chamber 14 has an interface device 17 configured to engage transmission line output point 13 whereby microwave power enters process chamber 14. Each process chamber 14 contains the workpiece to be heated, along with any desired fixture, molds, insulation, etc. The individual chambers 14 are transported, either individually (on casters, for instance) or on a conveyor (as shown schematically at 16), so that while one chamber is being actively heated, others may be waiting or cooling. Control of the atmosphere within each chamber 14, such as evacuation, backfilling, venting, etc., may be carried out during the waiting or cooling stages, thereby maximizing the time that microwave source 11 is utilized.

The entire process of heating the chambers 14 may be carried out in a controlled area. In such cases, it is desirable to remove as much equipment as possible to a remote location for ease of maintenance. For simplicity, this concept is shown in FIG. 1 as a wall 15 between the equipment room and the processing room.

### EXAMPLE 2

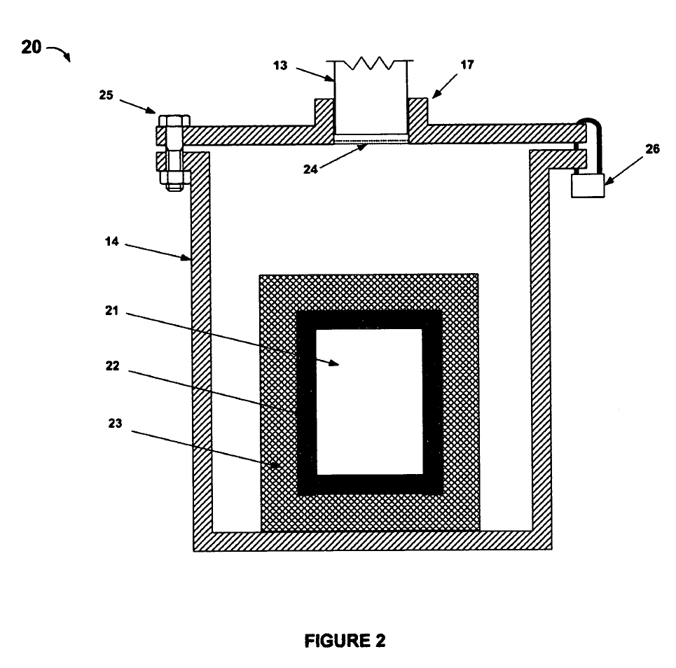

Referring to FIG. 2, an embodiment of the inventive process chamber 14 is shown in cross section at 20. Workpiece 21 in this case is contained in crucible 22, which in turn may optionally be surrounded by an insulating casket 23, hybrid heating materials, or other thermal management components, as are well known in the art of microwave processing. In this example, interface device 17 comprises a raised flange or boss to mechanically engage waveguide output point 13 and a dielectric window 24, through which microwave power enters chamber 14. Window 24 is preferably secured in place by brazing. The top of chamber 14 is secured to the body by bolts 25, lock 26, or other conventional means. The interface device may optionally contain additional features (not shown) intended to suppress leakage of microwave power from the area where the waveguide meets the interface device. These features may include gaskets, metal finger stock, steel braid, or other structures as are familiar to microwave engineers.

### EXAMPLE 3

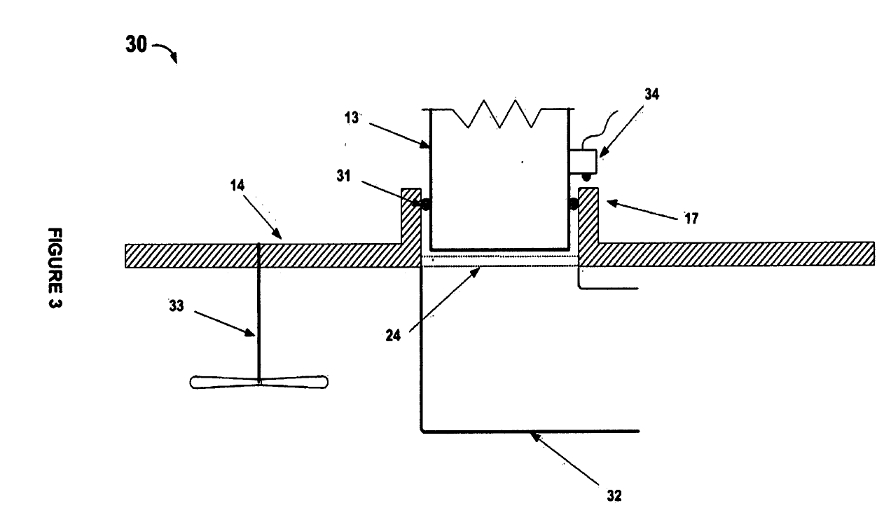

Illustrated at 30 in FIG. 3, an embodiment of the microwave transmission line of the present invention is shown in the expanded view of the top of chamber 14. The microwave waveguide is inserted and sealed using electromagnetic gaskets 31 or microwave chokes as are well known in the art of microwave processing. A mechanical switch 34 is located proximate to the waveguide, and this switch is part of a safety interlock system that prevents the microwave power feed from being energized unless the chamber 14 is securely engaged at the end of the feed.

Those skilled in the art of microwave system design will appreciate that microwave power may be transmitted via a waveguide such as that shown in FIG. 3 or may alternatively be transmitted via a coaxial transmission line. In the latter case, the interface device will comprise a coaxial feedthrough with an antenna structure or feed horn integral with chamber 14, whereby microwave power from a coaxial feed line will be effectively launched into chamber 14.

### EXAMPLE 4

During the process of microwave heating a need will frequently arise for various ancillary devices and process inputs. These may include means for gas inlets and outlets, vacuum pumping, stirring or agitation, and temperature measurement. Each of the foregoing functions will require a physical penetration in chamber 14. The modular design of the present invention makes it convenient to include such ancillary penetrations within or near the power interface. The respective mating components (gas lines, temperature probes, and the like) may, if desired, be physically attached to the microwave feed, whereby in one simple operation the feed can be brought down to engage the power interface while the other ancillary devices simultaneously engage their respective docking points or penetrations.

### EXAMPLE 5

The inventive process can be applied to various thermal treatments. One useful example is the melting and casting of metals. This operation may be carried out as follows. Insulation 23 is placed into chamber 14, a mold is positioned within insulation 23, and a crucible is positioned above the mold. A pour hole in the bottom of the crucible aligns with the inlet of the mold, and a stopper rod is placed to temporarily seal the pour hole. The stopper rod is preferably a refractory material having relatively low microwave loss. Metal to be melted is placed within the crucible and insulation is placed above the crucible to minimize radiative heat loss. The stopper rod is aligned with a mechanical link that passes through the wall of chamber 14. Chamber 14 is then secured and brought into position to engage the microwave power feed while the mechanical link engages an external actuator. Vacuum and/or gas feedthroughs and thermal sensor probes, if present, are also brought into engagement with their respective devices. The heating process is then conducted according to a selected profile and when the metal has reached the desired pour temperature, the actuator and link act to raise the stopper rod, thereby allowing the molten metal to flow downward and fill the mold. Chamber 14 is then disconnected from all external devices and service lines and moved aside to cool while another chamber is moved into position for heating.

### EXAMPLE 6

In the system of the previous examples, it is contemplated that chamber 14 (and possibly some components therein such as insulation structures and temperature probes) will normally be reusable to some degree. Alternatively, in other applications such as melting or vitrification of hazardous waste it may be desirable to make a chamber that will be used only once. In this case, the top may be welded onto the chamber rather than bolted. Microwave heating can then melt the hazardous material, simultaneously fusing it together with some of the surrounding insulation to form a stable, refractory mass. Depending on the nature of the hazardous material, the chamber may be sufficiently sturdy to be used as the shipping container during transport to the ultimate disposal site.

Applicants do not regard the particular outside dimensions or general shape of chamber 14 to be critical to practicing the invention. It will be appreciated that the external size and shape may in some cases be selected based on added engineering considerations. For hazardous waste processing as described in the foregoing example, the shape of chamber 14 may be chosen to optimize space utilization in the final waste repository.

As previously noted, the inventive system is especially useful for processing materials that may, for one reason or another, need to be protected from loss or theft. The processing chamber may therefore have various security features built into its design. The outer wall of the chamber is preferably of monolithic construction, such as a welded, spun, or deep-drawn metal cylinder. Small penetrations such as thermocouple feed-throughs, small observation ports, etc. are also preferably welded. The part of the chamber that may be opened (preferably the top) is normally attached to the lower portion by bolts, which may, in turn, be tamper-resistant or tamper indicating. The bolts may be further supplemented by locks, which may be of any suitable design, including, for example, padlocks or combination locks. When several locks are in use, it may be customary to assign different keys or combinations to different operators, whereby the chamber can only be opened by several operators working together and not by a single worker or intruder.

When the transmission line is a simple waveguide, it will be appreciated that the chamber must have a dielectric window of an appropriate size to engage the open end of the waveguide in order for microwave power to pass into the chamber. To prevent theft of the material if the dielectric window is broken, the chamber may further include a short, curved section of waveguide inside of the window, as shown at 32 in FIG. 3. This feature has the further beneficial effect of diverting the launch angle of microwave power to improve the power distribution within the chamber. Alternatively, as shown schematically in FIG. 3, a mode-stirring deflector 33 may be disposed under the window or elsewhere within chamber 14. The deflector may be fixed or it may be rotatable via an externally-powered drive mechanism.

### EXAMPLE 7

Several exemplary embodiments have been described in which the microwave source 11 and transmission line 12 are shown to be relatively stationary and the chambers 14 are movable to some degree. It will be appreciated that the same result can be had by keeping the chambers 14 fixed in place and moving some part of the power source 11, 12. Applicants consider either way of achieving relative movement between chamber 14 and power output 13 to be within the scope of the invention.

Those skilled in the art will appreciate that the exemplary drawings are not intended to limit the invention to particular geometrical forms. In particular, the securable opening and the power interface may be part of a common assembly, or they may be separate. For instance, the chamber may open from the top while the power may be introduced through a dielectric window in one side of the chamber. Alternatively, the chamber may open at the bottom (like a bell jar) so that a more complex assembly (insulation, molds, and the like) may be built up before the bulk of the chamber is lowered onto it and secured. The power interface may be located at virtually any convenient place on the chamber walls.

For simplicity, a single microwave power source has been shown in the drawings. It will be appreciated, however, that more than one power source may be used, and in that case the processing chamber will have separate interfaces corresponding to the several power sources. Because the chamber 14 is constructed primarily of metal, it serves to define the electrical boundary or “cavity” within which the workpiece is subjected to applied microwave power. Both single-mode and multimode cavities are well known in the art, as are both fixed- and variable-frequency microwave heating systems. The overall design principles that govern such systems are well established, and it will be understood that the invention may be adapted to any selected mode or frequency of operation without undue experimentation. If chamber 14 is intended to operate as a substantially single-mode cavity, various familiar features such as tuning stubs may be incorporated into either chamber 14 or transmission line 13. Alternatively, if chamber 14 is a multimode cavity intended to operate over a wide frequency range, a launcher or impedance transformer such as that disclosed in U.S. Pat. No. 5,721,286 may be usefully employed.

The modular nature of the inventive processing system gives the operator great latitude to process many different kinds of workpieces or products. It will be understood that different chambers can be constructed in different sizes, shapes, etc., all of which may be compatible with the same power interface. Since each particular chamber or workpiece will have a particular process recipe or heating profile, the system may further include means for identifying which particular chamber is in use, so that the power supply may automatically call up the appropriate operating profile. This may be accomplished by various conventional means. For instance, each chamber may be fitted with a bar code, RFID tag, etc., and the power supply fitted with a corresponding reader device. The identifying feature on the chamber may be substantially permanent (for example, if it is desired simply to identify which size of chamber is being used) or it may be programmable to some degree (for example, if a chamber of constant size may be used to process different workpieces).

### EXAMPLE 8

One contemplated mode of operation involves a first step in which the workpiece, insulation, fixtures, molds, etc. are arranged in the chamber. The chamber is then sealed and secured until the microwave source is available to process the workpiece. If the workpiece is an accountable material, the chamber may be locked down in a highly secure facility during this waiting period. Such facility may have a number of loaded chambers in storage, which might look substantially alike. Thus, to avoid confusion and processing mistakes, the operator places an identifying tag on the chamber as the final action in the loading and sealing step. The tag may be a substantially disposable printed bar code, which can be read and recorded by the processing system so as to keep track of a unique run or serial number. The tag may further contain a code that can be recognized by the processing system in order to initiate a specific process recipe. Alternatively, the tag may be a passive RFID tag or a more complex RF transponder that can be programmed to some degree in order to convey additional information to the processing unit.

Those skilled in the art will recognize that the tagging feature described in the foregoing example naturally lends itself to numerous uses as are well known in modern inventory management practices.

High power microwave sources are conventionally equipped with various safety features designed to prevent excessive microwave leakage. It will be appreciated that the inventive system will preferably contain interlocks that will disable the power supply if a chamber interface has not properly engaged with the transmission line. One suitable means for accomplishing this function is a mechanical switch such as that shown at 34 in FIG. 3. Other suitable means such as optical sensors, magnetic reed switches, etc., are well known in the art.

It will further be appreciated that in place of, or in addition to, gas feedthroughs and/or vacuum ports, the chamber 14 may contain other conventional devices (such as check valves or the like) for venting overpressure that may develop during the heating process.

In some of the exemplary designs it is contemplated that the chamber 14 is substantially movable and the transmission line 13 is relatively fixed. However, Applicant emphasizes that the inventive concept merely involves relative movability between these two components, i.e., the chamber or cavity is easily detachable from the microwave source. Those skilled in the art will understand that the invention may be equally well carried out by keeping the position of the chamber 14 relatively fixed and using a movable or flexible transmission line 13. Applicant considers either method of achieving relative movement (or using some combination of moving the chamber and moving the transmission line) to be within the spirit and scope of the invention as claimed.

We claim:

1. An apparatus for microwave processing, comprising:
a microwave source;
a transmission line adapted to carry power from said microwave source; and,
a detachable processing chamber adapted to maintain a selected internal environment, said chamber having an interface adapted to receive microwave power from said transmission line, whereby said chamber forms a microwave heating cavity wherein the contents of said chamber may be processed by exposure to said microwave power in said selected environment.

2. The apparatus of claim 1 wherein said microwave source comprises a device selected from the group consisting of: magnetrons, klystrons, gyrotrons, traveling wave tubes, and solid state power amplifiers.

3. The apparatus of claim 1 wherein said transmission line comprises a waveguide.

4. The apparatus of claim 1 wherein said interface comprises a substantially microwave-transparent window configured to sealably engage said transmission line.

5. The apparatus of claim 1 wherein said chamber further contains thermal insulation at least partially surrounding said contents

6. The apparatus of claim 1 wherein said chamber further contains an identifying device and said microwave source includes a control system adapted to utilize information from said identifying device.

7. The apparatus of claim 1 wherein said chamber is reusable.

8. The apparatus of claim 1 wherein said chamber is disposable and said contents are fused by said microwave heating to form a substantially solid mass, after which said chamber forms a permanent container for said fused contents.

9. A method for microwave processing comprising the following steps:
a. loading material to be processed into a portable metal chamber, said chamber having a securable opening and an interface adapted to admit microwave power from an external feed;
b. securing said opening;
c. moving said chamber into a position in which said interface engages said external feed; and,
d. applying microwave power through said interface and heating said material to a selected temperature for a selected time.

10. The method of claim 9 further comprising a step of establishing a selected atmosphere within said chamber.

11. The method of claim 9 wherein said heating step is sufficient to fuse said material into a substantially solid mass.

12. The method of claim 11 further comprising the step of disposing of said material at a selected repository site using said chamber as a permanent container for said material.

13. The method of claim 9 wherein said material is a metal and said chamber contains a crucible and a mold arranged such that when said metal becomes at least partially melted during said heating step, said metal may flow from said crucible into said mold.

14. The method of claim 9 wherein said material is at least partially liquid and said heating step is sufficient to cause a selected chemical reaction in said liquid.

15. A method for microwave processing comprising the following steps:
a. loading material to be processed into a portable metal chamber having a securable opening, a first interface adapted to admit microwave power from an external feed, and a second interface adapted to engage a second process input device;
b. securing the opening;
c moving the chamber into a position where said first interface engages said microwave power feed and said second interface engages its respective input device; and,
d. applying microwave power to heat said material while engaging said second process input device to control a selected aspect of the heating process.

16. The method of claim 15 wherein said second process input device is selected from the group consisting of: a source of process gas; a gas exhaust; a vacuum pump; a thermal measurement device; and, a mechanical feedthrough.

17. The method of claim 16 wherein said material to be heated is a liquid and said mechanical feedthrough is adapted to drive a stirring mechanism disposed within said liquid.

18. The method of claim 16 wherein said material to be heated is a metal to be melted in a crucible and said mechanical feedthrough is adapted to withdraw a plug from said crucible thereby allowing said metal to flow downward from said crucible into a mold.

19. The method of claim 15 wherein said first and second interfaces are co-located in a single assembly whereby said microwave power and said second process input may be engaged in a single operation.
